(19) United States
(12) Patent Application Publication
(10) Pub. No.: US 2017/0361454 A1
(43) Pub. Date: Dec. 21, 2017

(54) TOOL BOX

(71) Applicant: Wen-Chen HSU, Taichung City (TW)

(72) Inventor: Wen-Chen HSU, Taichung City (TW)

(21) Appl. No.: 15/184,436

(22) Filed: Jun. 16, 2016

(51) Int. Cl. B25H 3/02; B25H 3/00

(52) U.S. Cl. CPC B25H 3/02; B25H 3/003

(57) ABSTRACT

A tool box contains: a first accommodation part, a second accommodation part covering with or uncovering from the first accommodation part, and at least one housing portion arranged on the first accommodation part and the second accommodation part so as to mount at least one holder, respectively. The first accommodation part or the second accommodation part includes at least one engagement portion, and each of the at least one holder has at least one contacting portion so as to retain with the at least one engagement portion of the first accommodation part or the second accommodation part. Thereby, multiple tools are removed from or secured on the at least one holder easily.

### FIELD OF THE INVENTION

The present invention relates to a tool box which is capable of removing and securing at least one holder from and onto the tool box easily, and multiple tools are fixed on the at least one holder securely.

### BACKGROUND OF THE INVENTION

As shown in FIG. 1, a conventional tool box 10 contains a first accommodation part 11, a second accommodation part 12, and a connector 13 configured to rotatably connect the first accommodation part 11 and the second accommodation part 12 together. Each of the first accommodation part 11 and the second accommodation part 12 has a housing space, and the first accommodation part 11 has a tool holder 14 in which multiple housing cavities are arranged so as to accommodate tools 20 of different types, such as bits and connection rods.

In operation, the second accommodation part 12 is rotatably uncovered from the first accommodation part 11 so that the tools 20 are removed from the tool holder 14. However, the tool box 10 has defects as follows:

1. The second accommodation part 12 is covered onto and is uncovered from the first accommodation part 11 repeatedly so as to take out of the tools 20, thus causing inconvenient operation.

After taking out of the tools 20, they are placed outside the tool box 10 randomly, thus losing the tools 20 easily.

The tool box 10 is broken easily, after repeatedly covering and uncovering the second accommodation part 12 onto and from the first accommodation part 11.

The present invention has arisen to mitigate and/or obviate the afore-described disadvantages.

### SUMMARY OF THE INVENTION

The primary objective of the present invention is to provide a tool box which is capable of removing and securing at least one holder from and onto the tool box easily.

Further objective of the present invention is to provide a tool box in which multiple tools are fixed on the at least one holder securely.

Another objective of the present invention is to provide a tool box which avoid damage and prolongs service life.

### BRIEF DESCRIPTION OF THE DRAWINGS

FIG. 1 is a perspective view of a conventional tool box.

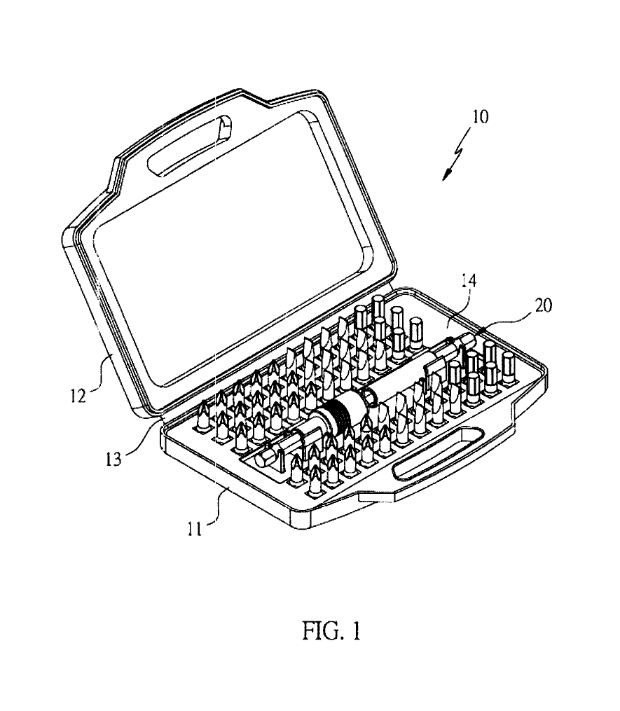

FIG. 2 is a perspective view showing the exploded components of a tool box according to a preferred embodiment of the present invention.

FIG. 3 is a perspective view showing the operation of the tool box according to the preferred embodiment of the present invention.

FIG. 4 is another perspective view showing the operation of the tool box according to the preferred embodiment of the present invention.

FIG. 5 is a side plane view showing the operation of the tool box according to the preferred embodiment of the present invention.

FIG. 6 is a front side view showing the operation of the tool box according to the preferred embodiment of the present invention.

FIG. 7 is also another perspective view showing the operation of the tool box according to the preferred embodiment of the present invention.

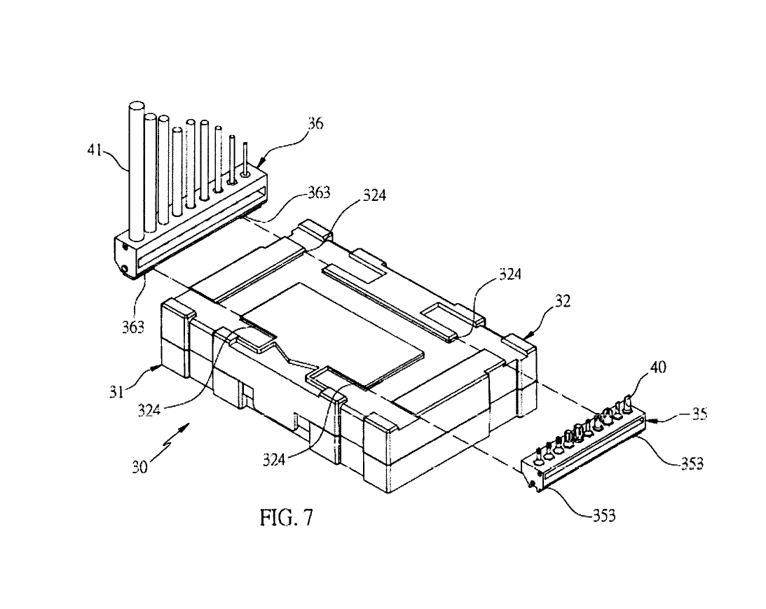

FIG. 8 is still another perspective view showing the operation of the tool box according to the preferred embodiment of the present invention.

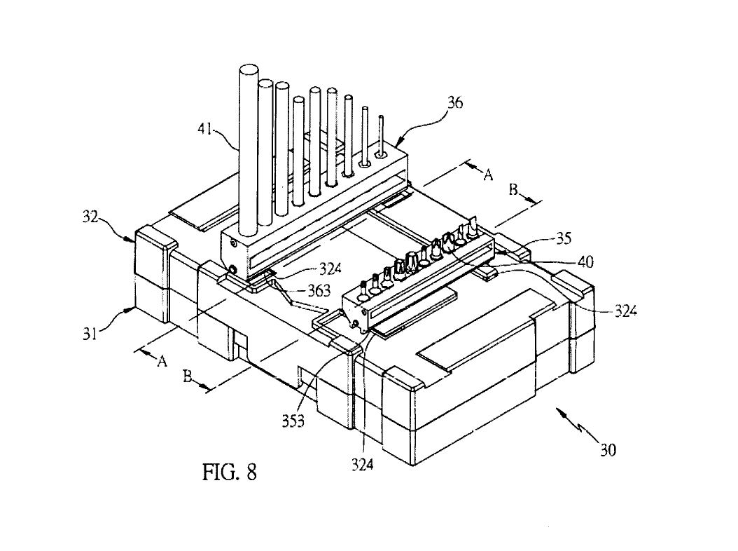

FIG. 9 is a cross sectional view taken along the line A-A of FIG. 8.

FIG. 10 is a cross sectional view taken along the line B-B of FIG. 8.

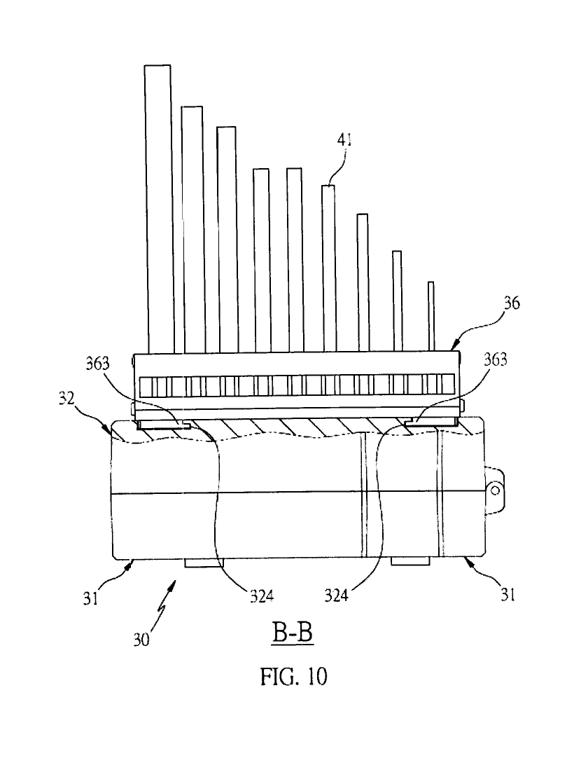

### DETAILED DESCRIPTION OF THE PREFERRED EMBODIMENTS

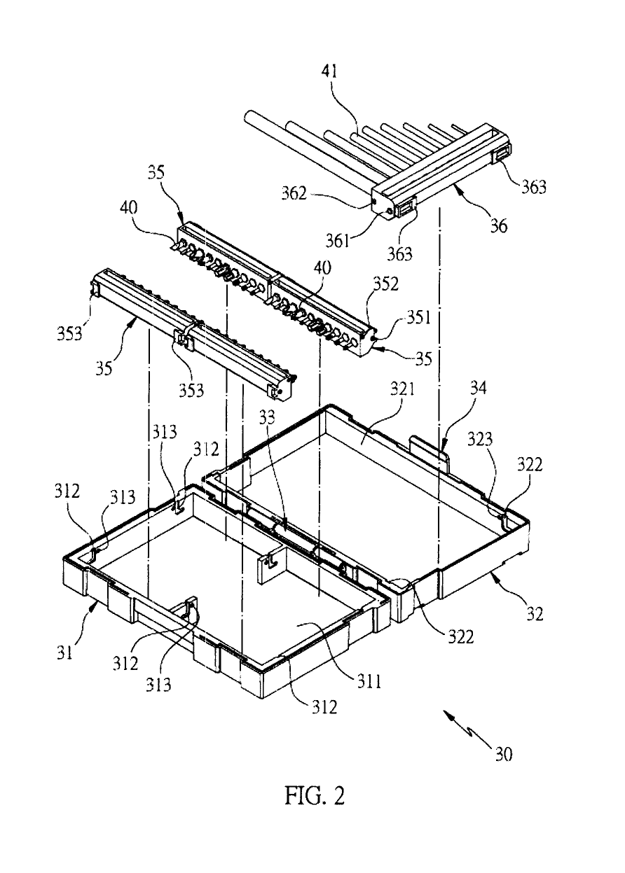

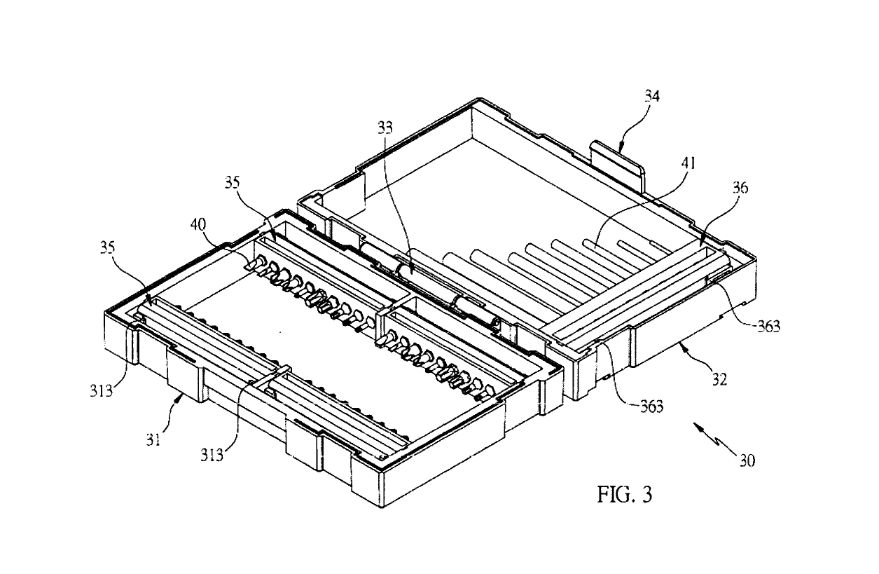

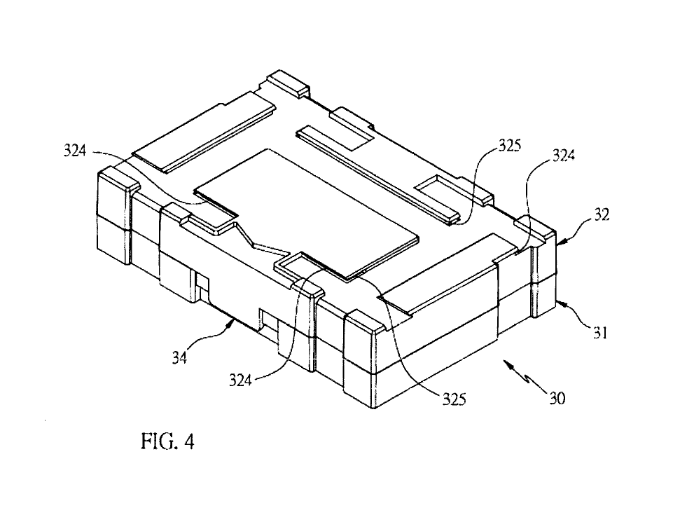

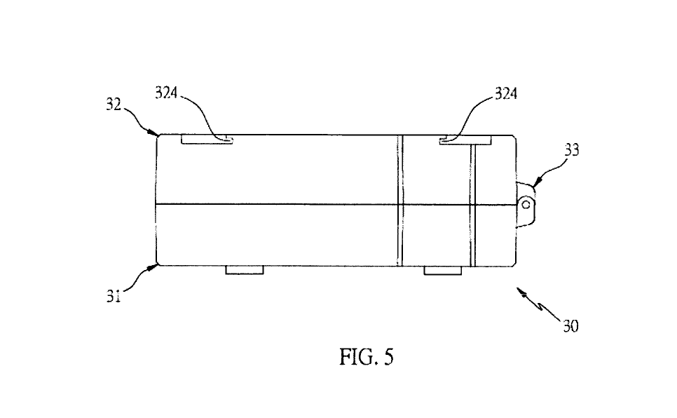

With reference to FIGS. 2 to 5, a tool box 30 according to a preferred embodiment of the present invention comprises: a first accommodation part 31, a second accommodation part 32, and at least one holder. Between a rear end of the first accommodation part 31 and a rear end of the second accommodation part 32 is defined a rotatable connection structure 33 so as to rotatably uncover the first accommodation part 31 from the second accommodation part 32 or to rotatably cover the first accommodation part 31 onto the second accommodation part 32. Between a front end of the first accommodation part 31 and a front end of the second accommodation part 32 is fixed a locking structure 34 configured to connect the first accommodation part 31 and the second accommodation part 32 together. Since the rotatable connection structure 33 and the locking structure 34 are well-known arts, further remarks are omitted. Each of the first accommodation part 31 and the second accommodation part 32 includes a housing portion in which the at least one holder is mounted so as to fix at least one tool. For example, the first accommodation portion 31 has a first housing portion 311 in which a plurality of first holders 35 are mounted, wherein each of the plurality of first holders 35 has multiple first tools 40 (such as bits) fixed in a top of said each first holder 35, and between said each first holder 35 and the first accommodation part 31 is defined a first coupling structure so that said each first holder 35 is secured in or removed from the first housing portion 311 of the first accommodation part 31. The first coupling structure has two first protrusions 351 arranged on two peripheral sides of said each first holder 35, respectively, and the first coupling structure also has two second protrusions 352 adjacent to the two first protrusions 351, individually. The first housing portion 311 of the first accommodation part 31 has two first L-shaped slots 312 defined on two peripheral sides thereof, respectively, wherein each of the two first L-shaped slots 312 corresponds to each of the two second protrusions 352, and the first housing portion 311 of the first accommodation part 31 also has two first trenches 313 respectively defined on the two peripheral sides thereof and adjacent to the two first L-shaped slots 312 so as to correspond to the two second protrusions 352 of said each first holder 35, such that the two first protrusions 351 of said each first holder 35 are individually placed into the two first L-shaped slots 312, and said each first holder 35 is rotated so that the two second protrusions 352 of said each first holder 35 contact with the two first trenches 313, respectively, and said each first holder 35 is mounted in or removed from the first housing portion 311 of the first accommodation part 31.

The second accommodation portion 32 has a second housing portion 321 in which a second holder 36 is mounted, wherein the second holder 36 has multiple second tools 41 (such as connection rods) secured in a top thereof, and between the second holder 36 and the second accommodation part 32 is defined a second coupling structure so that the second holder 36 is secured in or removed from the second housing portion 321 of the second accommodation part 32. The second coupling structure has two first projections 361 arranged on two peripheral sides of the second holder 36, respectively, and the second coupling structure also has two second projections 362 adjacent to the two first projections 361, individually. The second housing portion 321 of the second accommodation part 32 has two second L-shaped slots 322 defined on two peripheral sides thereof, respectively, wherein each of the two second L-shaped slots 322 corresponds to each of the two first projections 361, and the second housing portion 321 of the second accommodation part 32 also has two second trenches 323 respectively defined on the two ends thereof and adjacent to the two second L-shaped slots 322 so as to correspond to the two second projections 362 of the second holder 36, such that the two first projections 361 of the second holder 36 are individually placed into the two second L-shaped slots 322, and the second holder 36 is rotated so that the two second projections 362 of the second holder 36 contact with the two second trenches 323, respectively, and the second holder 36 is mounted in or removed from the second housing portion 321 of the second accommodation part 32. Furthermore, the first accommodation part 31 or the second accommodation part 32 includes at least one engagement portion, and each of said each first holder 35 and the second holder 36 has at least one contacting portion respectively. For example, the second accommodation part 32 includes two first engagement portions 324 (i.e., two first L-shaped recesses 324) and two second engagement portions 325 (i.e., two second L-shaped recesses 325) which are formed on a top thereof. Said each first holder 35 has two first L-shaped contacting portions 353 (i.e., two first L-shaped blocks 353) arranged on a bottom thereof so as to correspond to the two first engagement portions 324 and the two second engagement portions 325 of the second accommodation part 32, and the second holder 36 has two second L-shaped contacting portions 363 (i.e., two second L-shaped blocks 363) configured to correspond to the two first engagement portions 324 and the two second engagement portions 325 of the second accommodation part 32, such that the second L-shaped contacting portions 363 engage into the two first engagement portions 324 or the two second engagement portions 325, individually.

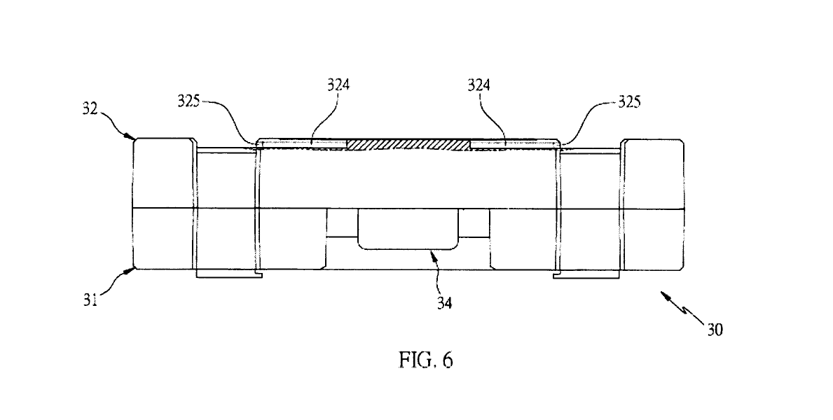

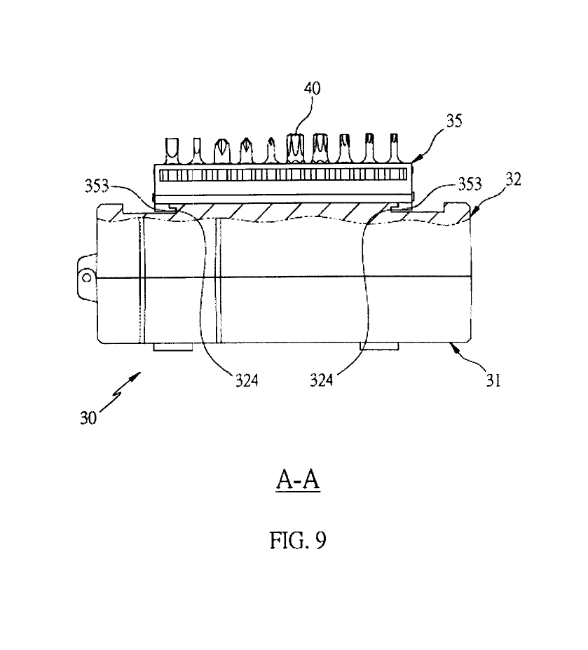

Referring to FIGS. 6 and 9, in operation, said each first holder 35 is removed from the first accommodation part 31 and the second holder 36 is removed from the second accommodation part 32, then the two first L-shaped contacting portions 353 of said each first holder 35 and the two second L-shaped contacting portions 363 of the second holder 36 are respectively retained into the two first engagement portions 324 or the two second engagement portions 325 of the second accommodation part 32. In this embodiment, the two first L-shaped contacting portions 353 of said each first holder 35 and the two second L-shaped contacting portions 363 of the second holder 36 are respectively retained into the two first engagement portions 324 of the first accommodation part 32, hence said each first holder 35 and the second holder 36 are fixed on the top of the second accommodation part 32. Thereafter, the multiple first tools 40 are removed from or secured on said each first holder 35, and the multiple second tools 41 are removed from or secured on the second holder 36 easily.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A tool box comprising: a first accommodation part, a second accommodation part covering with or uncovering from the first accommodation part, and at least one housing portion arranged on the first accommodation part and the second accommodation part so as to mount multiple holders, respectively;
wherein the first accommodation part or the second accommodation part includes at least one engagement portion, and each of the multiple holders has at least one contacting portion respectively so as to retain with the at least one engagement portion of the first accommodation part or the second accommodation part;
wherein the multiple holders are a plurality of first holders and a second holder;
wherein the first accommodation part has a first housing portion in which the plurality of first holders are mounted;
wherein the second accommodation part has a second housing portion in which the second holder is mounted;
wherein between each of the plurality of first holders and the first accommodation part is defined a first coupling structure;
wherein between the second holder and the second accommodation part is defined a second coupling structure.

2. The tool box as claimed in claim 1, wherein between a rear end of the first accommodation part and a rear end of the second accommodation part is defined a rotatable connection structure so as to rotatably uncover the first accommodation part from the second accommodation part or to rotatably cover the first accommodation part onto the second accommodation part.

3. The tool box as claimed in claim 1, wherein between a front end of the first accommodation part and a front end of the second accommodation part is fixed a locking structure configured to connect the first accommodation part and the second accommodation part together.

4. (canceled)

5. The tool box as claimed in claim 1, wherein the first coupling structure has two first protrusions arranged on two peripheral sides of said each first holder, respectively, and the first coupling structure also has two second protrusions adjacent to the two first protrusions, individually; the first housing portion of the first accommodation part has two first L-shaped slots defined on two peripheral sides thereof, respectively, wherein each of the two first L-shaped slots corresponds to each of the two second protrusions, and the first housing portion of the first accommodation part also has two first trenches respectively defined on the two peripheral sides thereof and adjacent to the two first L-shaped slots so as to correspond to the two second protrusions of said each first holder.

6. (canceled)

7. The tool box as claimed in claim 1, wherein the second coupling structure has two first projections arranged on two peripheral sides of the second holder, respectively, and the second coupling structure also has two second projections adjacent to the two first projections, individually; the second housing portion of the second accommodation part has two second L-shaped slots defined on two peripheral sides thereof, respectively, wherein each of the two second L-shaped slots corresponds to each of the two first projections, and the second housing portion of the second accommodation part also has two second trenches respectively defined on the two ends thereof and adjacent to the two second L-shaped slots so as to correspond to the two second projections of the second holder.

8. The tool box as claimed in claim 4, wherein the second accommodation part includes two first engagement portions and two second engagement portions which are formed on a top thereof.

9. The tool box as claimed in claim 1, wherein the second accommodation part includes two first engagement portions and two second engagement portions which are formed on a top thereof.

10. The tool box as claimed in claim 8, wherein said each first holder has two first L-shaped contacting portions arranged on a bottom thereof so as to correspond to the two first engagement portions and the two second engagement portions of the second accommodation part.

11. The tool box as claimed in claim 9, wherein said each first holder has two first L-shaped contacting portions arranged on a bottom thereof so as to correspond to the two first engagement portions and the two second engagement portions of the second accommodation part.

12. The tool box as claimed in claim 8, wherein the second holder has two second L-shaped contacting portions configured to correspond to the two first engagement portions and the two second engagement portions of the second accommodation part.

13. The tool box as claimed in claim 9, wherein the second holder has two second L-shaped contacting portions configured to correspond to the two first engagement portions and the two second engagement portions of the second accommodation part.
